(19) United States
(12) Patent Application Publication
(10) Pub. No.: US 2009/0023054 A1
(43) Pub. Date: Jan. 22, 2009

(54) Lithium cell

(76) Inventors: Zhiping Jiang, Westfield, MA (US); William L. Bowden, Nashua, NH (US); Leigh Friguglietti, Westfield, MA (US); Thomas N. Koulouris, Belmont, MA (US)

Correspondence Address: MR. BARRY D. JOSEPHS;ATTORNEY AT LAW, 19 NORTH STREET, SALEM, MA, 01970, US

(21) Appl. No.: 11/879,097

(22) Filed: Jul. 16, 2007

(51) Int. Cl. H01M 6/14; H01M 2/14; H01M 4/06

(52) U.S. Cl. 429/94; 429/129; 429/163

(57) ABSTRACT

A primary cell having an anode comprising lithium and a cathode comprising iron disulfide (FeS₂) and carbon particles. The electrolyte comprises a lithium salt dissolved in a nonaqueous solvent mixture which contains a tin iodide (SnI₂) additive. A cathode slurry is prepared comprising iron disulfide powder, carbon, binder, and a liquid solvent. The mixture is coated onto a conductive substrate and solvent evaporated leaving a dry cathode coating on the substrate. The anode and cathode can be spirally wound with separator therebetween and inserted into the cell casing with electrolyte then added.

### FIELD OF THE INVENTION

The invention relates to lithium primary cells having an anode comprising lithium and a cathode comprising iron disulfide and an electrolyte comprising a lithium salt and nonaqueous solvent which includes an additive of tin iodide (SnI₂).

### BACKGROUND

Primary (non-rechargeable) electrochemical cells having an anode of lithium are known and are in widespread commercial use. The anode is comprised essentially of lithium metal. Such cells typically have a cathode comprising manganese dioxide, and electrolyte comprising a lithium salt such as lithium trifluoromethane sulfonate (LiCF₃SO₃) dissolved in a nonaqueous solvent. The cells are referenced in the art as primary lithium cells (primary Li/MnO₂ cells) and are generally not intended to be rechargeable. Alternative primary lithium cells with lithium metal anodes but having different cathodes, are also known. Such cells, for example, have cathodes comprising iron disulfide (FeS₂) and are designated Li/FeS₂ cells. The iron disulfide (FeS₂) is also known as pyrite. The Li/MnO₂ cells or Li/FeS₂ cells are typically in the form of cylindrical cells, typically an AA size cell or 2/3A size cell. The Li/MnO₂ cells have a voltage of about 3.0 volts which is twice that of conventional Zn/MnO₂ alkaline cells and also have higher energy density (watt-hrs per cm³ of cell volume) than that of alkaline cells. The Li/FeS₂ cells have a voltage (fresh) of between about 1.2 and 1.5 volts which is about the same as a conventional Zn/MnO₂ alkaline cell. However, the energy density (watt-hrs per cm³ of cell volume) of the Li/FeS₂ cell is much higher than a comparable size Zn/MnO₂ alkaline cell. The theoretical specific capacity of lithium metal is high at 3861.7 mAmp-hr/gram and the theoretical specific capacity of FeS₂ is 893.6 mAmp-hr/gram. The FeS₂ theoretical capacity is based on a 4 electron transfer from 4Li per FeS₂ molecule to result in reaction product of elemental iron Fe and 2Li₂S. That is, 2 of the 4 electrons reduce the valence state of Fe⁺² in FeS₂ to Fe and the remaining 2 electrons reduce the valence of sulfur from −1 in FeS₂ to −2 in Li₂S. In order to carry out the electrochemical reaction the lithium ions, Li⁺, produced at the anode must transport through the separator and electrolyte medium and to the cathode.

Overall the Li/FeS₂ cell is much more powerful than the same size Zn/MnO₂ alkaline cell. That is for a given continuous current drain, particularly for higher current drain over 200 milliAmp, in the voltage vs. time profile the voltage drops off much less quickly for the Li/FeS₂ cell than the Zn/MnO₂ alkaline cell. This results in a higher energy output obtainable from a Li/FeS₂ cell compared to that obtainable for a same size alkaline cell. The higher energy output of the Li/FeS₂ cell is also clearly shown more directly in graphical plots of energy (Watt-hrs) versus continuous discharge at constant power (Watts) wherein fresh cells are discharged to completion at fixed continuous power outputs ranging from as little as 0.01 Watt to 5 Watt. In such tests the power drain is maintained at a constant continuous power output selected between 0.01 Watt and 5 Watt. (As the cell's voltage drops during discharge the load resistance is gradually decreased raising the current drain to maintain a fixed constant power output.) The graphical plot Energy (Watt-Hrs) versus Power Output (Watt) for the Li/FeS₂ cell is considerably above that for the same size alkaline cell. This is despite that the starting voltage of both cells (fresh) is about the same, namely, between about 1.2 and 1.5 volt.

Thus, the Li/FeS₂ cell has the advantage over same size alkaline cells, for example, AAA, AA, C or D size or any other size cell in that the Li/FeS₂ cell may be used interchangeably with the conventional Zn/MnO₂ alkaline cell and will have greater service life, particularly for higher power demands. Similarly the Li/FeS₂ cell which is primary (nonrechargeable) cell can be used as a replacement for the same size rechargeable nickel metal hydride cells, which have about the same voltage (fresh) as the Li/FeS₂ cell.

The Li/MnO₂ cell and Li/FeS₂ cell both require non aqueous electrolytes, since the lithium anode is highly reactive with water. One of the difficulties associated with the manufacture of a Li/FeS₂ cell is the need to add good binding material to the cathode formulation to bind the Li/FeS₂ and carbon particles together in the cathode. The binding material must also be sufficiently adhesive to cause the cathode coating to adhere uniformly and strongly to the metal conductive substrate to which it is applied.

The cathode material may be initially prepared in a form such as a slurry mixture, which can be readily coated onto the metal substrate by conventional coating methods. The electrolyte added to the cell must be a suitable nonaqueous electrolyte for the Li/FeS₂ system allowing the necessary electrochemical reactions to occur efficiently over the range of high power output desired. The electrolyte must exhibit good ionic conductivity and also be sufficiently stable, that is non reactive, with the undischarged electrode materials (anode and cathode components) and also non reactive with the discharge products. This is because undesirable oxidation/reduction reactions between the electrolyte and electrode materials (either discharged or undischarged) could thereby gradually contaminate the electrolyte and reduce its effectiveness or result in excessive gassing. This in turn can result in a catastrophic cell failure. Thus, the electrolyte used in Li/FeS₂ cell in addition to promoting the necessary electrochemical reactions, should also be stable to discharged and undischarged electrode materials. Additionally, the electrolyte should enable good ionic mobility and transport of the lithium ion (Li⁺) from anode to cathode so that it can engage in the necessary reduction reaction resulting in LiS₂ product in the cathode.

Primary lithium cells are in use as a power source for digital flash cameras, which require operation at higher pulsed power demands than is supplied by individual alkaline cells. Primary lithium cells are conventionally formed of an electrode composite comprising an anode formed of a sheet of lithium, a cathode formed of a coating of cathode active material comprising FeS₂ on a conductive metal substrate (cathode substrate) and a sheet of electrolyte permeable separator material therebetween. The electrode composite may be spirally wound and inserted into the cell casing, for examples, as shown in U.S. Pat. No. 4,707,421. A cathode coating mixture for the Li/FeS₂ cell is described in U.S. Pat. No. 6,849,360. A portion of the anode sheet is typically electrically connected to the cell casing which forms the cell's negative terminal. The cell is closed with an end cap which is insulated from the casing. The cathode sheet can be electrically connected to the end cap which forms the cell's positive terminal. The casing is typically crimped over the peripheral edge of the end cap to seal the casing's open end. The cell may be fitted internally with a PTC (positive thermal coefficient) device or the like to shut down the cell in case the cell is exposed to abusive conditions such as short circuit discharge or overheating.

The anode in a Li/FeS₂ cell can be formed by laminating a layer of lithium on a metallic substrate such as copper. However, the anode may be formed of a sheet of lithium without any substrate.

The electrolyte used in a primary Li/FeS₂ cells are formed of a “lithium salt” dissolved in an “organic solvent”. Representative lithium salts which may be used in electrolytes for Li/FeS₂ primary cells are referenced in U.S. Pat. No. 5,290,414 and U.S. Pat. No. 6,849,360 B2 and include such salts as: Lithium trifluoromethanesulfonate, LiCF₃SO₃ (LiTFS); lithium bistrifluoromethylsulfonyl imide, Li(CF₃SO₂)₂N (LiTFSI); lithium iodide, LiI; lithium bromide, LiBr; lithium tetrafluoroborate, LiBF₄; lithium hexafluorophosphate, LiPF₆; lithium hexafluoroarsenate, LiAsF₆; Li(CF₃SO₂)₃C, and various mixtures. In the art of Li/FeS₂ electrochemistry lithium salts are not always interchangeable as specific salts work best with specific electrolyte solvent mixtures.

In U.S. Pat. No. 5,290,414 (Marple) is reported use of a beneficial electrolyte for FeS₂ cells, wherein the electrolyte comprises a lithium salt dissolved in a solvent comprising 1,3-dioxolane in admixture with a second solvent which is an acyclic (non cyclic) ether based solvent. The acyclic (non cyclic) ether based solvent as referenced may be dimethoxyethane (DME), ethyl glyme, diglyme and triglyme, with the preferred being 1,2-dimetoxyethane (DME). As given in the example the 1,2-dimethoxyethane (DME) is present in the electrolyte in substantial amount, i.e., at either 40 or 75 vol. % (col. 7, lines 47-54). A specific lithium salt ionizable in such solvent mixture(s), as given in the example, is lithium trifluoromethane sulfonate, LiCF₃SO₃. Another lithium salt, namely lithium bistrifluoromethylsulfonyl imide, Li(CF₃SO₂)₂N also mentioned at col. 7, line 18-19. The reference teaches that a third solvent may optionally be added selected from 3,5-dimethlyisoxazole (DMI), 3-methyl-2-oxazolidone, propylene carbonate (PC), ethylene carbonate (EC), butylene carbonate (BC), tetrahydrofuran (THF), diethyl carbonate (DEC), ethylene glycol sulfite (EGS), dioxane, dimethyl sulfate (DMS), and sulfolane (claim 19) with the preferred being 3,5-dimethylisoxazole.

In U.S. Pat. No. 6,849,360 B2 (Marple) is disclosed an electrolyte for an Li/FeS₂ cell, wherein the electrolyte comprises the salt lithium iodide dissolved in the organic solvent mixture comprising 1,3-dioxolane (DX), 1,2-dimethoxyethane (DME), and small amount of 3,5 dimethylisoxazole (DMI). (col. 6, lines 44-48.)

Thus, it should be evident from the above representative references that the choice of a particular organic solvent or mixture of different organic solvents for use in conjunction with any one or more lithium salts to produce a suitable electrolyte for the Li/FeS₂ cell is challenging. This is not to say that many combinations of lithium salts and organic solvents do not produce a Li/FeS₂ cell will not work at all. But rather the challenge associated with such cells using an electrolyte formed with just any combination of known lithium salt and organic solvent is that the problems encountered will likely be very substantial, thus making the cell impractical for commercial usage. The history of development of lithium cells in general, whether lithium primary cells, e.g. non rechargeable Li/MnO₂ or Li/FeS₂ cells or rechargeable lithium or lithium ion cells reveals that just any combination of lithium salt and organic solvent cannot be expected to result in a good cell, that is, exhibiting good, reliable performance. Thus, references which merely provide long lists of possible organic solvents for Li/FeS₂ cells do not necessarily teach combinations of solvents or combination of specific lithium salts in specific solvent mixtures, which exhibit particular or unexpected benefit.

Accordingly, it is desired to produce a Li/FeS₂ cell employing an effective electrolyte therein which promotes ionization of the lithium salt in the electrolyte and is sufficiently stable that it does not degrade with time and does not degrade the anode or cathode components.

It is desired that the electrolyte comprising a lithium salt dissolved in an organic solvent provide for good ionic mobility of the lithium ions through the electrolyte so that the lithium ions may pass at good transport rate from anode to cathode through the separator.

It is desired to produce a primary (nonrechargeable) Li/FeS₂ cell having good rate capability that the cell may be used in place of rechargeable batteries to power digital cameras.

### SUMMARY OF THE INVENTION

The invention is directed to lithium primary cells wherein the anode comprises lithium metal. The lithium may be alloyed with small amounts of other metal, for example aluminum, which typically comprises less than about 1 wt. % of the lithium alloy. The lithium which forms the anode active material, is preferably in the form of a thin foil. The cell has a cathode comprising the cathode active material iron disulfide (FeS₂), commonly known as “pyrite”. The cell may be in the form of a button (coin) cell or flat cell. Desirably the cell may be in the form of a spirally wound cell comprising an anode sheet and a cathode composite sheet spirally wound with separator therebetween. The cathode sheet is produced using a slurry process to coat a cathode mixture comprising iron disulfide (FeS₂) particles onto a conductive surface which can be a conductive metal substrate. The FeS₂ particles are bound to the conductive substrate using desirably an elastomeric, preferably, a styrene-ethylene/butylene-styrene (SEBS) block copolymer such as Kraton G1651 elastomer (Kraton Polymers, Houston, Tex.). This polymer is a film-former, and possesses good affinity and cohesive properties for the FeS₂ particles as well as for conductive carbon particle additives in the cathode mixture.

In an aspect of the invention the cathode is formed of a cathode slurry comprising iron disulfide (FeS₂) powder, conductive carbon particles, binder material, and solvent. (The term “slurry” as used herein will have its ordinary dictionary meaning and thus be understood to mean a wet mixture comprising solid particles.) The wet cathode slurry is coated onto a conductive substrate such as a sheet of aluminum or stainless steel. The conductive substrate functions as a cathode current collector. The solvent is then evaporated leaving dry cathode coating mixture comprising the iron disulfide material and carbon particles preferably including carbon black adhesively bound to each other and with the dry coating bound to the conductive substrate. The preferred carbon black is acetylene black. The carbon may optionally include graphite particles blended therein.

After the wet cathode slurry is coated onto the conductive substrate, the coated substrate is placed in an oven and heated at elevated temperatures until the solvent evaporates, as disclosed in commonly assigned U.S. patent application Ser. No. 11/516534, filed Sep. 6, 2006. The resulting product is a dry cathode coating comprising iron disulfide and carbon particles bound to the conductive substrate. On a dry basis, the cathode preferably contains no more than 4% by weight binder, and between 85 and 95% by weight of FeS₂. The solids content, that is, the FeS₂ particles and conductive carbon particles in the wet cathode slurry is between 55 and 70 percent by weight. The viscosity range for the cathode slurry is from about 3500 to 15000 mpas. (mpas=mNewton×sec/m²). After the anode comprising lithium metal and cathode comprising iron disulfide, with separator therebetween, are inserted into the cell housing, a nonaqueous electrolyte is added to the cell.

In a principal aspect of the invention the desired nonaqueous electrolyte for the lithium/iron disulfide (Li/FeS₂) cell comprises a lithium salt dissolved in an organic solvent and an additive of tin iodide (also known as stannous iodide) of formula SnI₂. It has been determined that when an additive of tin iodide (SnI₂) is added to certain non aqueous electrolytes the presence of the SnI₂ in the electrolyte can markedly improve the properties of the electrolyte for use in the primary lithium/iron disulfide cell. More specifically, it has been determined that the addition of the tin iodide (SnI₂) to certain non aqueous electrolytes retards the rate of buildup of a passivation layer on the surface of the lithium anode. The addition of SnI₂ to the electrolyte appears to induce a stable passivation coating or film on the surface of the lithium metal anode. By inducing a stable passivation layer on the lithium anode surface is meant that SnI₂ additive to the electrolyte may allow some formation of a passivation layer on the surface of the anode, but then the rate of buildup of the passivation layer appears to slow dramatically or cease entirely. Thus, although the SnI₂ does not prevent formation of some passivation layer on the surface of the lithium anode, the presence of the SnI₂ in the electrolyte appears to prevent or at least retard the rate of continued buildup of the passivation layer. That is, the presence of the SnI₂ in the electrolyte tends to stabilize the passivation layer either by retarding its rate of buildup or preventing continued and unabated buildup of the passivation layer on the surface of the lithium anode. This in turn improves cell performance and capacity of the primary lithium/iron disulfide cell.

It has been determined that the beneficial effects of the SnI₂ additive can be realized in the primary Li/FeS₂ cell when the SnI₂ is added to non aqueous electrolyte solvents comprising 1,2-dimethoxyethane (DME). 1,2-dimethoxyethane (DME) (also known as ethylene glycoldimethylether) is an acyclic (non cyclic) organic solvent of structural formula:

CH₃OCH₂CH₂OCH₃ (I)

It has a Chemical Abstracts Service Registry CAS No. 110-71-4. 1,2-demethoxyethane (DME) is a water white liquid with boiling point 85.2° C., a viscosity of about 0.455 centipoise and a dielectric constant of 7.20. The SnI₂ desirably comprises between about 1000 and 5000 parts per million parts (PPM) by weight of the total electrolyte (lithium salt plus solvents plus SnI₂). Typically the SnI₂ comprises between about 1000 and 4000 ppm, for example, between about 2000 and 4000 ppm of the electrolyte.

The beneficial effects of the SnI₂ additive have been observed in the primary Li/FeS₂ cell in particular when the electrolyte includes an electrolyte solvent comprising 1,2-dimethoxyehtane (DME). The beneficial effect of the SnI₂ additive has been observed when the electrolyte solvent includes 1,2-dimethoxyethane solvent and the lithium salt dissolved therein is selected from a variety of lithium salts such as lithium bistrifluoromethylsulfonyl imide, Li(CF₃SO₂)₂N (LiTFSI) or lithium iodide (LiI) or lithium phosphoroushexafluoride (LiPF₆).

In particular the beneficial effects of the SnI₂ additive can be realized in the primary Li/FeS₂ cell when it is added to an electrolyte solvent mixture comprising a nonaqueous solvent mixture comprising 1,2-dimethoxyethane (DME) and sulfolane. The sulfolane is a cyclic compound having the molecular formula C₄H₈O₂S and a Chemical Abstracts Service Registry (CAS) No. 126-33-0. Sulfolane is a clear colorless liquid having a boiling point of 285° C., a viscosity of 10.28 centipoise (at 30° C.), and a dielectric constant of 43.26 (at 30° C.). The structural formula for sulfolane is represented as follows:

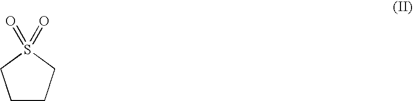

It has been determined that the SnI₂ can be added beneficially to another electrolyte solvent mixture comprising 1,2-dimethoxyethane (DME) and ethylene carbonate. The ethylene carbonate is a cyclic diether and has the molecular formula C₃H₄O₃ and a CAS no. 96-49-1. Ethylene carbonate has a boiling of 248° C., a viscosity of 1.85 centipoise (at 40° C.), and a dielectric constant of 89.6 (at 40° C.). The structural formula for ethylene carbonate is represented as follows:

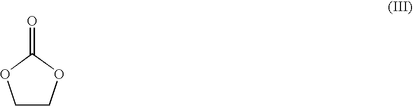

A preferred electrolyte for the primary Li/FeS₂ cell comprises the lithium salt lithium bistrifluoromethylsulfonyl imide, Li (CF₃SO₂)₂N (LiTFSI) which is dissolved in a solvent mixture comprising 1,2-dimethoxyethane (DME) and sulfolane with SnI₂ also added to the electrolyte. As a non limiting example, a preferred electrolyte may comprise 0.8 moles per liter of the lithium salt Li(CF₃SO₂)₂N (LiTFSI) dissolved in a 80:20 volume ratio of 1,2-dimethoxyethane DME to sulfolane with about 3200 ppm by weight of SnI₂ also added to the electrolyte. The electrolyte may contain Li(CF₃SO₂)₂N (LiTFSI) salt dissolved in solvent mixture comprising 1,2-dimethoxyethane (DME) in amount between about 50 and 95 vol. percent and sulfolane in amount between about 5 and 50 vol. percent and SnI₂ added desirably in amount between about 1000 and 5000 ppm of the total electrolyte.

Another preferred electrolyte for the Li/FeS2 cell comprises the lithium salt lithium iodide (LiI) dissolved in a solvent mixture comprising 1,2-dimethoxyethane (DME) and sulfolane with SnI₂ also added to the electrolyte. As a non limiting example, a preferred electrolyte may comprise 1.0 moles per liter of the lithium iodide (LiI) salt dissolved in a 80:20 volume ratio of 1,2-dimethoxyethane (DME) to sulfolane with about 3300 ppm by weight of SnI₂ also added to the electrolyte. The electrolyte may contain lithium iodide salt dissolved in solvent mixture comprising 1,2-dimethoxyethane (DME) in amount between about 50 and 95 vol. percent and sulfolane in amount between about 5 and 50 vol. percent and SnI₂ added desirably in amount between about 1000 and 5000 ppm of the total electrolyte.

Another preferred electrolyte for the primary Li/FeS2 cell comprises the lithium salt lithiumphosphoroushexafluoride (LiPF₆) dissolved in a solvent mixture comprising 1,2-dimethoxyethane (DME) and ethylene carbonate (EC) with SnI₂ also added to the electrolyte. As a non limiting example, a preferred electrolyte may comprise 0.8 moles per liter of the lithium salt LiPF₆ dissolved in a 80:20 volume ratio of 1,2-dimethoxyethane (DME) to ethylene carbonate (EC) with about 2000 ppm by weight of SnI₂ also added to the electrolyte. The electrolyte may contain LiPF₆ salt dissolved in solvent mixture comprising 1,2-dimethoxyethane (DME) in amount between about 50 and 95 vol. percent and ethylene carbonate (EC) in amount between about 5 and 50 vol. percent and SnI₂ added desirably in amount between about 1000 and 5000 ppm of the total electrolyte.

The lithium salt in the above first two preferred electrolytes may comprise lithium trifluoromethane sulfonate, LiCF₃SO₃ (LiTFS) as a substiture for the lithium bistrifluoromethylsulfonyl imide, Li(CF₃SO₂)₂N (LITFSI) or in admixture with the LiTFSI, but the latter is the preferred lithium salt.

The electrolyte solvent mixture of the invention may be free of any dioxolane. That is, the electrolyte solvent mixture of the invention may contain only trace amounts of any dioxolane, for example, 1,3-dioxolane or other dioxolane including alkyl-substituted dioxolanes, such as but not limited to methyldioxolane and diethyldioxolane, and mixtures thereof. Thus, the term dioxolane as used herein shall be understood to include 1,3-dioxolane and alkyl-substituted dioxolanes and mixtures thereof. Such trace amount of dioxolanes in total may comprise, less than 200 ppm of the solvent mixture, e.g. less than 100 ppm or, e.g., less than 50 ppm of the solvent mixture. At such low concentrations (and even at somewhat higher amount) such trace amounts of the dioxolanes would not be expected to serve any particular or substantive function. Thus, the term electrolyte solvent mixture being “essentially free” of dioxolane as used herein shall be understood to refer to such trace amount of dioxolanes in total which may be present in the electrolyte solvent, but is present in such small (trace) amounts that it would serve no particular or substantive function.

The electrolyte mixture of the invention provides the electrochemical properties needed to allow efficient electrochemical discharge of the Li/FeS₂ cell. In particular the electrolyte mixture of the invention provides the electrochemical properties needed to satisfy even high rate pulsed discharge demands of high power electronic devices such as digital cameras. Thus, an Li/FeS₂ cell can be produced using the electrolyte mixture of the invention resulting as a suitable primary cell for use in a digital camera normally powered by a rechargeable cell. Aside from exhibiting very good electrochemical properties which allows efficient discharge of the Li/FeS₂ cell, the electrolyte solvent mixture of the invention has the advantage of having low viscosity.

Applicants herein have determined that in a Li/FeS₂ cell it is advantageous to have an electrolyte of relatively low viscosity, desirably between about 0.9 and 1.5 centipoise. The use of electrolyte solvents for Li/FeS₂ cells with higher viscosity does not necessarily mean that the electrolyte will result in an inoperable or poor cell. Nevertheless, applicants believe that electrolyte solvents of low viscosity will more likely result in beneficial properties for the Li/FeS₂ cell. However, it will be appreciated that the electrolyte mixture as a whole must also exhibit the necessary electrochemical properties making it suitable for use in the Li/FeS₂ cell.

In order for the Li/FeS₂ cell to discharge properly lithium ions (Li⁺) from the anode must have enough ionic mobility enabling good transport across the separator and into the FeS₂ cathode. At the cathode the lithium ions participate in the reduction reaction of sulfur ions producing Li₂S at the cathode. The reason that electrolytes of low viscosity are highly desirable for the Li/FeS₂ cell is 1) that it reduces lithium ion (Li⁺) concentration polarization within the electrolyte and 2) it promotes good lithium ion (Li⁺) transport mobility during discharge. In particular the low viscosity electrolyte for the Li/FeS₂ cell reduces lithium ion concentration polarization and promotes better lithium ion transport from anode to cathode when the cell is discharged at high pulsed rate, for example, when the Li/FeS₂ cell is used to power a digital camera. Lithium ion concentration polarization is characterized by the concentration gradient present between the Li anode and the FeS₂ cathode as the lithium ion transports from anode to cathode. A high lithium ion concentration gradient is an indicator of a poor rate of lithium ion transport and is more apt to occur when the electrolyte has a high viscosity. When the electrolyte has a high viscosity, lithium ions tend to buildup at or near the anode surface during cell discharge, while the supply of lithium ions at the cathode surface becomes much less by comparison, thus resulting in a high lithium ion concentration gradient.

A low viscosity electrolyte for the Li/FeS₂ cell is desirable in that it can reduce the lithium ion buildup at the anode and thus reduces the level of lithium ion concentration gradient between anode and cathode. The low viscosity of the electrolyte improves the lithium ion (Li⁺) mobility, namely, the rate of transport of lithium ions from anode to cathode. As a result of the increased lithium ion mobility the performance of the Li/FeS₂ cell can improve, especially at high rate discharge conditions.

The electrolyte may desirably be added to the Li/FeS₂ cell in amount equal to about 0.4 gram electrolyte solution per gram FeS₂.

The electrolyte mixture of the invention may be beneficially employed in a coin (button) cell or wound cell for the Li/FeS₂ cell system.

### BRIEF DESCRIPTION OF THE DRAWINGS

FIG. 1A is a cross sectional view of an improved Li/FeS₂ cell of the invention as presented in a button cell embodiment.

FIG. 1B is a plan view of a spacer disk for insertion into the cell of FIG. 1A.

FIG. 1C is plan view of a spring ring for insertion into the cell of FIG. 1A.

FIG. 1D is a cross sectional view of the spring ring of FIG. 1C.

FIG. 1 is a pictorial view of an improved Li/FeS₂ cell of the invention as presented in a cylindrical cell embodiment.

FIG. 2 is a partial cross sectional elevation view of the cell taken through sight lines 2-2 of FIG. 1 to show the top and interior portion of the cell.

FIG. 3 is a partial cross sectional elevation view of the cell taken through sight lines 2-2 of FIG. 1 to show a spirally wound electrode assembly.

FIG. 4 is a schematic showing the placement of the layers comprising the electrode assembly.

FIG. 5 is a plan view of the electrode assembly of FIG. 4 with each of the layers thereof partially peeled away to show the underlying layer.

### DETAILED DESCRIPTION

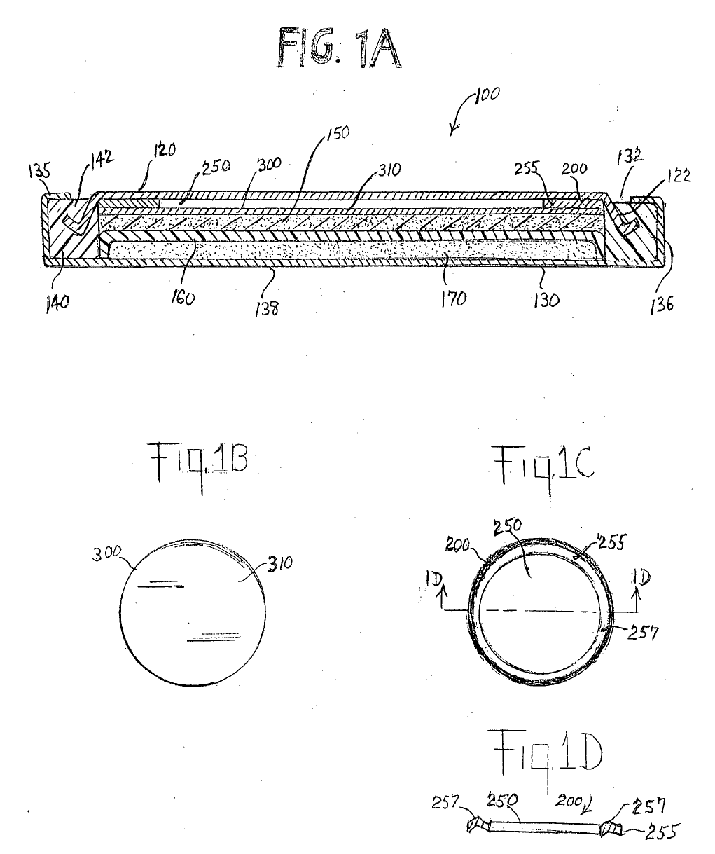

The Li/FeS₂ cell of the invention may be in the form of a flat button (coin) cell or a spirally wound cell. A desirable button cell 100 configuration comprising a lithium anode 150 and a cathode 170 comprising iron disulfide (FeS₂) with separator 160 therebetween is shown in the FIG. 1A.

The Li/FeS₂ cell as in cell 100 has the following basic discharge reactions (one step mechanism):

Anode:

4Li=4Li⁺+4e Eq. 1

Cathode:

FeS₂+4Li⁺+4e=Fe+2Li₂S Eq. 2

Overall:

FeS₂+4Li=Fe+2Li₂S Eq. 3

An embodiment of a Li/FeS₂ button (coin) cell 100 of the invention is shown in FIG. 1A. Cell 100 is a primary (nonrechargeable) cell. In the button cell 100 (FIG. 1A) a disk-shaped cylindrical cathode housing 130 is formed having an open end 132 and a closed end 138. Cathode housing 130 is preferably formed from nickel-plated steel. An electrical insulating member 140, preferably a plastic cylindrical member of disk shape having a hollow core, can be inserted into housing 130 so that the outside surface of insulating member 140 abuts and lines the inside surface of cathode housing 130 side walls 136. Alternatively, the inside surface of side walls 136 may be coated with a polymeric material that solidifies into insulator 140 abutting the inside surface of housing 130. Insulator 140 may first be fitted over the side walls 122 of the anode housing 120 before insertion into cathode housing 130. Insulator 140 can be formed from a variety of thermally stable insulating materials, but is preferably formed of polypropylene.

The cathode 170 comprising iron disulfide (FeS₂) powder dispersed therein, can be prepared in the form of a slurry which may be coated directly onto a conductive substrate sheet (not shown) which is desirably a sheet of aluminum, aluminum alloy, or stainless steel. A preparation of the cathode, per se, (electrolyte not yet added to the cell) is described in commonly assigned application Ser. No. 11/516,534, filed Sep. 6, 2006 and portions also included herein for completeness. Desirably the cathode 170 in the form of a slurry can be first coated on one side of the conductive substrate, then dried, and the same cathode slurry may be coated on the other side of the conductive substrate and likewise dried to form the final cathode 170. The finished cathode 170 can be stored in sheets until ready for insertion into the cell housing. The conductive substrate onto which the cathode 170 slurry is coated, desirably of aluminum, aluminum alloy, or stainless steel may have a plurality of small apertures therein, thus forming a grid or screen. For example, the conductive substrate sheet may be a sheet of stainless steel, desirably in the form of expanded stainless steel metal foil, having a plurality of small apertures therein. Alternatively, the conductive sheet (not shown) onto which the cathode slurry 170 is coated, on one or preferably both sides, may be a sheet of aluminum or aluminum alloy without any apertures therethrough. Such latter configuration is convenient for preparing durable test cathodes for button cell 100. Such durable test cathodes 170 as above indicated can be stored in sheets until ready for insertion into the cell housing.

The cathode slurry comprises 2 to 4 wt % of binder (Kraton G1651 elastomeric binder from Kraton Polymers, Houston Tex.); 50 to 70 wt % of active FeS₂ powder; 4 to 7 wt % of conductive carbon (carbon black and graphite); and 25 to 40 wt % of solvent(s). (The carbon black may include in whole or in part acetylene black carbon particles. Thus, the term carbon black as used herein shall be understood to extend to and include carbon black and acetylene black carbon particles.) The Kraton G1651 binder is an elastomeric block copolymer (styrene-ethylene/butylene (SEBS) block copolymer) which is a film-former. This binder possesses sufficient affinity for the active FeS₂ and carbon black particles to facilitate preparation of the wet cathode slurry and to keep these particles in contact with each other after the solvents are evaporated. The FeS₂ powder may have an average particle size between about 1 and 100 micron, desirably between about 10 and 50 micron. A desirable FeS₂ powder is available under the trade designation Pyrox Red 325 powder from Chemetall GmbH, wherein the FeS₂ powder has a particle size sufficiently small that of particles will pass through a sieve of Tyler mesh size 325 (sieve openings of 0.045 mm). (The residue amount of FeS₂ particles not passing through the 325 mesh sieve is 10% max.) A suitable graphite is available under the trade designation Timrex KS6 graphite from Timcal Ltd. Timrex graphite is a highly crystalline synthetic graphite. (Other graphites may be employed selected from natural, synthetic, or expanded graphite and mixtures thereof, but the Timrex graphite is preferred because of its high purity.) The carbon black is available under the trade designation Super P conductive carbon black (BET surface of 62 m²/g) from Timcal Co.

The solvents use to form the wet cathode slurry preferably include a mixture of C₉-C₁₁ (predominately C₉) aromatic hydrocarbons available as ShellSol A100 hydrocarbon solvent (Shell Chemical. Co.) and a mixture of primarily isoparaffins (average M.W. 166, aromatic content less than 0.25 wt. %) available as Shell Sol OMS hydrocarbon solvent (Shell Chemical Co.). The weight ratio of ShellSol A100 to ShellSol OMS solvent is desirably at a 4:6 weight ratio. The ShellSol A100 solvent is a hydrocarbon mixture containing mostly aromatic hydrocarbons (over 90 wt % aromatic hydrocarbon), primarily C₉ to C₁₁ aromatic hydrocarbons. The ShellSol OMS solvent is a mixture of isoparaffin hydrocarbons (98 wt. % isoparaffins, M.W. about 166) with less than 0.25 wt % aromatic hydrocarbon content. The slurry formulation may be dispersed using a double planetary mixer. Dry powders are first blended to ensure uniformity before being added to the binder solution in the mixing bowl.

A preferred cathode slurry mixture is presented in Table 1:

TABLE I
Cathode Slurry

| | Wet Slurry |
|---|---|
| | (wt. %) |
| Binder | 2.0 |
| (Kraton G1651) | |
| Hydorcarbon Solvent | 13.4 |
| (ShellSol A100) | |
| (ShellSol OMS) | 20.2 |
| FeS₂ Powder | 58.9 |
| (Pyrox Red 325) | |
| Graphite | 4.8 |
| (Timrex KS6) | |
| Carbon Black | 0.7 |
| (Super P) | |
| Total | 100.0 |

This same or similar wet cathode slurry mixture (electrolyte not yet added to the cell) is disclosed in commonly assigned application Ser. No. 11/516,534, filed Sep. 6, 2006. The total solids content of the wet cathode slurry mixture 170 is shown in above Table 1 is 66.4 wt. %

The wet cathode slurry 170 is coated onto at least one side of the above mentioned conductive substrate (not shown) desirably a sheet of stainless steel, aluminum or aluminum alloy. The conductive sheet may have perforations or apertures therein or may be a solid sheet without such perforations or apertures. The wet cathode slurry 170 may be coated onto the conductive substrate using intermittent roll coating technique. The cathode slurry coated on the conductive substrate is dried gradually adjusting or ramping up the temperature from an initial temperature of 40° C. to a final temperature of about 130° C. in an oven until the solvent has all evaporated. (Drying the cathode slurry in this manner avoids cracking.) This forms a dry cathode coating 170 comprising FeS₂, carbon particles, and binder on the conductive substrate. Optionally the opposite side of the conductive substrate may be coated with the same or similar wet cathode slurry 170. This second wet cathode coating 170 is likewise dried in the same manner as the first coating. The coated cathode is then passed between calendering rolls to obtain the desired dry cathode thicknesses. A representative desirable thickness of dry cathode coating 170 is between about 0.170 and 0.186 mm, preferably about 0.171 mm. The dry cathode coating 170 thus has the following desirable formulation: FeS₂ powder (89 wt. %); Binder (Kraton G1651), 3 wt. %; Graphite (Timrex KS6), 7 wt. %, and Carbon Black (Super P), 1 wt %. The carbon black (Super P carbon black) develops a carbon network which improves conductivity.

A durable dry cathode 170 sheet is thus formed in this manner. The cathode 170 sheet may be set aside until ready to be cut to proper size for insertion into the cell housing.

There can be variations in the sequence of assembling and loading the cell contents into the cell housing. However it has been determined that button cell 100 can be conveniently assembled in the following manner to form a completed cell suitable for use or testing:

Cell 100 can be formed conveniently by loading the anode housing 120, preferably of nickel plated steel, with all of the necessary cell components, including the electrolyte. Then the cathode housing 130, preferably of aluminum plated steel, can be inserted and crimped over the anode housing 120 to tightly close the cell. Thus, a durable cell 100, can be assembled by first inserting insulator disk 142, preferably of polypropylene, over the anode housing 120 so that it covers the side walls 122 of said housing 120 (FIG. 1A). Then spring ring 200 (FIG. 1C) can be inserted into the anode housing 120 so that it lies against the inside surface of the closed end of said housing as shown in FIG. 1A. Spring ring 200, preferably of stainless steel, has a central aperture 250 therethrough bounded by circumferential ring surface 255. Ring surface 255 is not flat but rather has integral convolutions 257 therein as shown in FIG. 1D. The convolutions 257 gives ring 200 a spring action when it is inserted in the anode housing 120 as pressure is applied to the ring. Next one or more spacer disks 300, preferably of stainless steel, can be inserted into anode housing 120 so that it presses onto spring ring 200 as shown in FIG. 1A. The spacer disks 300 can be solid flat disks as shown in FIG. 1B. A plurality of such spacer disks 300 can be employed to assure a tight fit of the cell contents within the completed cell. A lithium anode sheet 150, of lithium or lithium alloy metal, can then be inserted into the anode housing so that it lies against spacer disk 300 as shown in FIG. 1A. The anode housing can be inverted so that its open end is on top. Separator sheet 160, preferably of microporous polypropylene, can then be inserted against the lithium anode sheet 150.

The nonaqueous electrolyte solution of the invention, preferably comprising a mixture of Li(CF₃SO₂)₂N (LiTFSI) salt dissolved in an organic solvent mixture comprising about 80 volume percent 1,2-dimethoxyethane (DME) and about a 20 volume percent sulfolane (SL) can then be poured over the exposed surface of the separator sheet 160 so that it becomes absorbed into the separator. The dry Cathode sheet 170 above described comprising the FeS₂ actives, can be cut to proper size and then inserted against the exposed side of the separator sheet 160. In this manner all of the cell components are inserted into the anode housing 120. The cathode housing 130 can then be inserted over the anode housing 120 so that the side wall 136 of the cathode housing 130 covers side wall 122 of anode housing 120 with insulator 140 therebetween. The edge 135 of the cathode housing 130 is crimped over the exposed insulator edge 142. The edge 135 bites into the insulator edge 142 to close the cell and tightly seal the cell contents therein. This results in a durable button cell 100 which resists electrolyte leakage.

In finding an effective and stable electrolyte for the primary Li/FeS₂ cell the following factors should be considered: The electrolyte comprises a lithium salt dissolved in a non aqueous solvent or solvent mixture. It has been determined herein that the electrolyte for the primary Li/FeS₂ cell desirably have a relatively low viscosity. It has been determined advantageous that the electrolyte have a viscosity of less than about 1.7 centipoise, desirably less than about 1.5 centipoise, preferably between about 0.9 and 1.5 centipoise, for example, between about 1.0 and 1.5. The low level viscosity of the electrolyte makes it more likely that there will be good ionic mobility, that is, good transport of the lithium ions from anode to cathode where they are needed to react with the FeS₂ in the cathode. Additionally, the low level viscosity of the electrolyte reduces the degree of lithium ion concentration polarization from occurring, especially when the cell is subjected to high rate or high power discharge. When the electrolyte has a high viscosity, lithium ions tend to buildup at or near the anode surface during cell discharge, while the supply of lithium ions at the cathode surface becomes starved or much less by comparison. A low viscosity electrolyte for the Li/FeS₂ cell can reduce the lithium ion buildup at the anode and can increase the supply of lithium ion approaching the cathode. The supply of lithium ions (Li⁺) at the cathode increases because of the improved ionic mobility of the lithium ions through the electrolyte medium. As a result the cell performance improves, especially at high rate discharge conditions.

Another consideration is that in finding a good electrolyte is that the electrolyte exhibit good ionic conductively. It has been determined by Applicants herein that the primary Li/FeS₂ cell, which includes a lithium salt dissolved in the nonaqueous solvent mixture of the invention, may desirably have a measured ionic conductivity of between about 5 and 15 milliSiemens/cm. The electrolyte solvent mixture desirably has properties which promote dissociation of the lithium salt to be dissolved therein. The dielectric constant for the solvent mixture, is one indicator of whether a particular solvent or solvent mixture will promote good dissociation (ionization) of the salt thereby allowing more of the lithium salt to dissolve and remain dissolved in the solvent. (Other inherent physiochemical properties of the solvent may also be factors in establishing whether good solubility of the lithium salt is achieved.) A solvent with high dielectric constant implies that the solvent may have the property of keeping certain charged ions apart and thereby implies that good dissociation (solubility) of the lithium salt may be achieved. It has been determined that the electrolyte solvent mixture of the invention for the primary Li/FeS₂ cell desirably has a dielectric constant greater than about 10, desirably between about 10 and 100, for example, between about 20 and 90 (at 25° C.). The final electrolyte (lithium salt dissolved in electrolyte solvent mixture) for the Li/FeS₂ cell desirably has a viscosity of less than about 1.7 centipoise, for example, between about 0.9 and 1.5 centipoise (at 25° C.) and the electrolyte ionic conductivity may be between about 5 and 15 milliSiemens/cm or even higher, if possible.

Another consideration in forming an effective and stable electrolyte for the primary Li/FeS₂ cell is that the electrolyte be unreactive with the lithium anode and also be unreactive with cathode components which includes iron disulfide, conductive carbon, and binder material. The electrolyte must be stable as well and not degrade significantly with time or when subjected to variations in ambient temperature reflecting normal cell usage conditions.

Yet another consideration in forming an effective electrolyte is that the electrolyte not exacerbate the problem of lithium anode passivation, which is a problem associated with lithium cells in general. When the primary Li/FeS₂ cell is discharged or left in storage for extended periods a passivation coating or film gradually develops on the lithium anode surface. The passivation layer can reach a certain level without interfering significantly with cell performance and to some degree can even be beneficial in that it can protect the lithium anode from deleterious side reaction with the electrolyte. However, rapid and continued buildup of the passivation layer on the surface of the lithium anode is undesirable, since such continued, unabated buildup of the passivation layer can significantly increase the cell's internal resistance. This in turn can lower the cell's power output capability and reduce performance and capacity. Thus, it is desirable that the electrolyte for the Li/FeS₂ cell induce a stable passivation layer on the anode surface. That is, the electrolyte should not cause or promote a rapid and continued buildup of the passivation layer on the surface of the anode as the cell is discharged under normal usage or stored for extended periods.

A desirable electrolyte of the invention for the Li/FeS₂ cell has been determined to comprise the lithium salts lithium trifluoromethanesulfonate having the chemical formula LiCF₃SO₃ which can be referenced simply as LiTFS and/or lithium bistrifluoromethylsulfonyl imide having the formula Li(CF₃SO₂)₂N which can be referenced simply as LiTFSI. The latter salt LiTFSI is preferred for the Li/FeS₂ cell in part because its higher conductivity. Another suitable lithium salt for the electrolyte is lithium iodide (LiI) and yet another lithium salt is lithium phosphoroushexafluoride (LiPF₆). It has been determined that a suitable electrolyte solvent mixture for the primary Li/FeS₂ cell may comprise 1,2-dimethoxyethane (DME) in admixture with either sulfolane (SL) or ethylene carbonate (EC). The solvent mixture comprising 1,2-dimethoxyehtane (DME) and sulfolane is preferred. An electrolyte solvent mixture of 1,2-dimethoxyehtane (DME) and sulfolane for possible use in a Li/FeS₂ cell is disclosed in commonly assigned application Ser. No. 11/494,725, filed Jul. 27, 2006.

It has been determined in the present invention that when an additive of tin iodide (SnI₂) is added to certain nonaqueous electrolyte solvents or solvent mixtures, the presence of the SnI₂ in the electrolyte can markedly improve the properties of the electrolyte for use in the primary lithium/iron disulfide cell. More specifically, it has been determined that the addition of the tin iodide (SnI₂) to certain nonaqueous electrolytes retards the rate of buildup of a passivation layer on the surface of the lithium anode. The addition of SnI₂ to the electrolyte appears to a induce a stable passivation coating or film on the surface of the lithium metal anode. That is, the presence of SnI₂ in the electrolyte may allow formation of some passivation layer on the surface of the anode, but then the rate of buildup appears to slow dramatically or cease entirely. Thus, the presence of the SnI₂ in the electrolyte tends to stabilize the passivation layer either by retarding its rate of buildup or preventing continued and unabated buildup of the passivation layer on the surface of the lithium anode. This in turn improves cell performance and capacity of the primary lithium/iron disulfide cell.

A preferred electrolyte for the primary Li/FeS₂ cell comprises the lithium salt lithium bistrifluoromethylsulfonyl imide, Li(CF₃SO₂)₂N (LiTFSI) which is dissolved in a solvent mixture comprising 1,2-dimethoxyethane (DME) and sulfolane with SnI₂ also added to the electrolyte. By way of non limiting example, a preferred electrolyte may comprise 0.8 moles per liter of the lithium salt Li(CF₃SO₂)₂N (LiTFSI) dissolved in a 80:20 volume ratio of 1,2-dimethoxyethane (DME) to sulfolane with about 3200 ppm by weight of SnI₂ also added to the electrolyte.

Another preferred electrolyte for the Li/FeS2 cell comprises the lithium salt lithium iodide (LiI) dissolved in a solvent mixture comprising 1,2-dimethoxyethane (DME) and sulfolane with SnI₂ also added to the electrolyte. As a non limiting example, a preferred electrolyte may comprise 1.0 moles per liter of the lithium iodide (LiI) salt dissolved in a 80:20 volume ratio of 1,2-dimethoxyethane (DME) to sulfolane with about 3300 ppm by weight of SnI₂ also added to the electrolyte.

Another preferred electrolyte for the primary Li/FeS2 cell comprises the lithium salt lithium phosphoroushexafluoride (LiPF₆) dissolved in a solvent mixture comprising 1,2-dimethoxyethane (DME) and ethylene carbonate (EC) with SnI₂ also added to the electrolyte. As a non limiting example, a preferred electrolyte may comprise 0.8 moles per liter of the lithium salt LiPF₆ dissolved in a 80:20 volume ratio of 1,2-dimethoxyethane (DME) to ethylene carbonate (EC) with about 2000 ppm by weight of SnI₂ also added to the electrolyte. The above electrolytes of the invention with SnI₂ additive is added to the cell in amount equal to about 0.4 gram electrolyte solution per gram FeS₂.

Such electrolyte mixture has been determined to be a very effective electrolyte for the Li/FeS₂ system. The electrolyte of the invention provides an effective medium allowing ionization of the Li(CF₃SO₂)₂N (LiTFSI) salt therein. The electrolyte does not noticeably react with or degrade the lithium anode or cathode components which includes FeS₂, conductive carbon, and binder.

The electrolyte formed of the lithium salt dissolved in the above described solvents with SnI₂ added therein has a very desirable viscosity of between about 0.9 and 1.5 centipoise, typically between about about 1.0 and 1.5 centipoise. Such low viscosity for the electrolyte reduces the chance of lithium ion (Li+) concentration polarization and improves lithium ionic mobility and transport of the lithium ions from anode to cathode. This improves the Li/FeS₂ cell performance even when the cell is discharged at elevated pulsed current rate needed to power digital cameras. Additionally, the electrolyte of the invention with SnI₂ additive therein appears to alleviate the problem of lithium anode passivation in the Li/FeS₂ cell. It appears that the presence of the SnI₂ in the electrolyte induces a stabilized lithium anode passivation layer. That is, the SnI₂ in the electrolyte appears to reduce the rate of continued buildup of the passivation layer on the lithium anode surface.

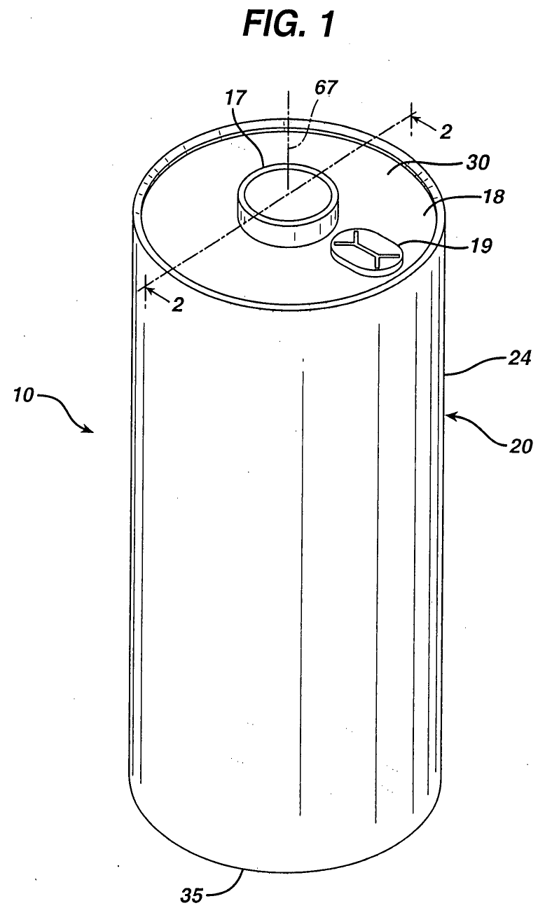

In another embodiment the Li/FeS₂ cell may be in the configuration of a cylindrical cell 10 as shown in FIG. 1. The cylindrical cell 10 may have a spirally wound anode sheet 40, cathode 60 with separator sheet 50 therebetween as shown in FIGS. 2-5. The Li/FeS₂ cell 10 internal configuration, apart from the difference in cathode composition, may be similar to the spirally wound configuration shown and described in U.S. Pat. No. 6,443,999. The anode sheet 40 as shown in the figures comprises lithium metal and the cathode sheet 60 comprises iron disulfide (FeS₂) commonly known as “pyrite”. The cell is preferably cylindrical as shown in the figures and may be of any size, for example, AAAA (42×8 mm), AAA (44×9 mm), AA (49×12 mm), C (49×25 mm) and D (58×32 mm) size. Thus, cell 10 depicted in FIG. 1 may also be a 2/3 A cell (35×15 mm). However, it is not intended to limit the cell configuration to cylindrical shape. Alternatively, the cell of the invention may have an anode comprising lithium metal and a cathode comprising iron disulfide (FeS₂) having the composition and nonaqueous electrolyte as herein described in the form of a spirally wound prismatic cell, for example a rectangular cell having the overall shape of a cuboid.

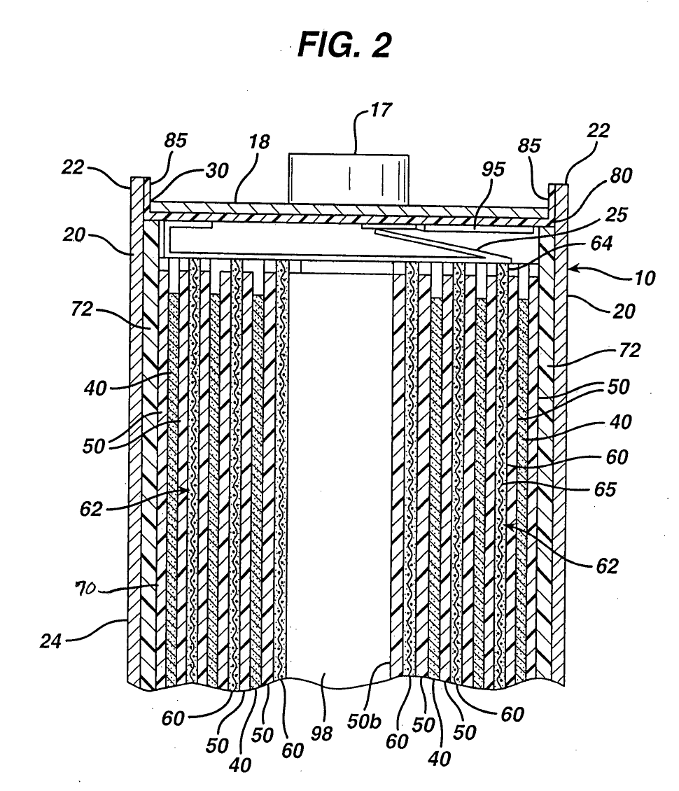

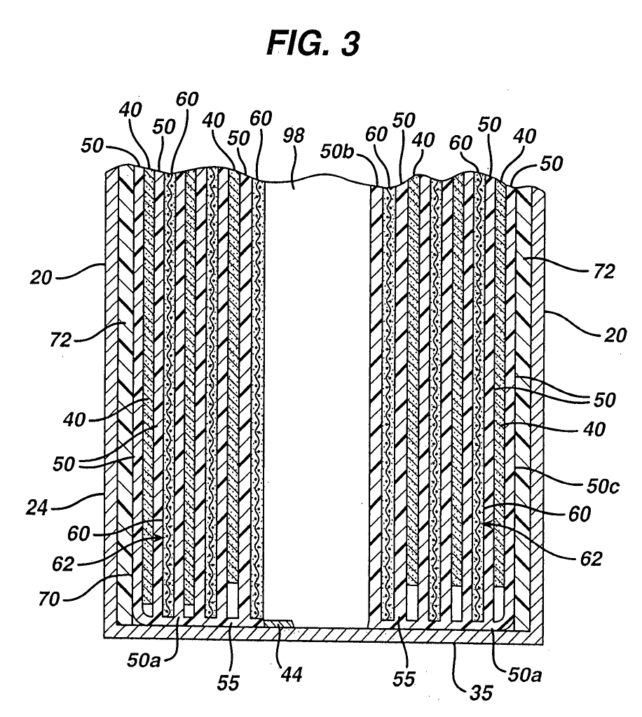

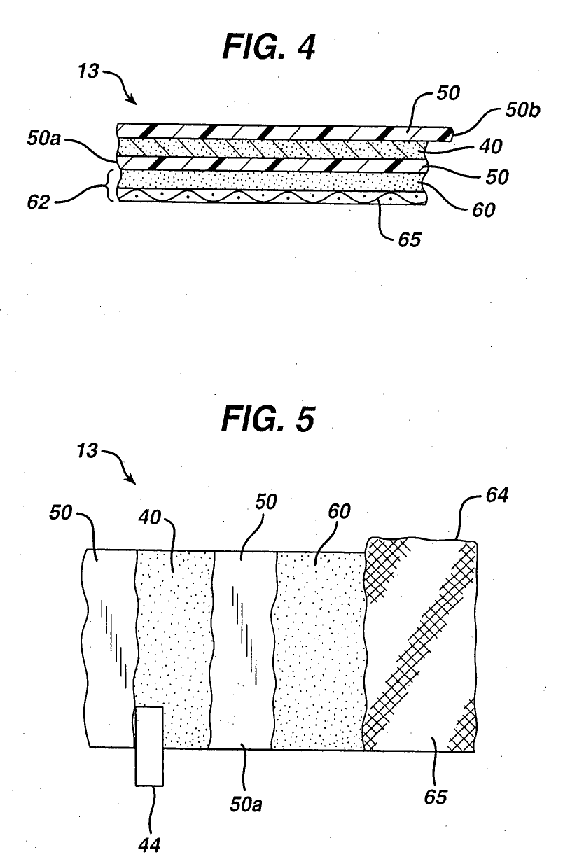

For a spirally wound cell, a preferred shape of the cell casing (housing) 20 is cylindrical as shown in FIG. 1. A similar wound cell structural configuration for the Li/FeS₂ cell is also shown and described in commonly assigned patent application Ser. No. 11/516534, filed Sep. 6, 2006. Casing 20 is preferably formed of nickel plated steel. The cell casing 20 (FIG. 1) has a continuous cylindrical surface. The spiral wound electrode assembly 70 (FIG. 3) comprising anode 40 and cathode composite 62 with separator 50 therebetween can be prepared by spirally winding a flat electrode composite 13 (FIGS. 4 and 5). Cathode composite 62 comprises a layer of cathode 60 comprising iron disulfide (FeS₂) coated onto metallic substrate 65 (FIG. 4).

The electrode composite 13 (FIGS. 4 and 5) can be made in the following manner: The cathode 60 comprising iron disulfide (FeS₂) powder dispersed therein can be initially prepared in the form of a wet slurry which is coated onto a conductive substrate sheet or metal foil 65. The conductive substrate 65 may be a sheet of aluminum or stainless steel, for example, expanded metal foil of aluminum or stainless steel (FIG. 4). If an aluminum sheet 65 is used it may be a sheet of aluminum without openings therethrough or may be a sheet of expanded aluminum foil (EXMET expanded aluminum foil) with openings therethrough thus forming a grid or screen. (EXMET aluminum or stainless steel foil from Dexmet Company, Branford, Conn.). The expanded metal foil may have a basis weight of about 0.024 g/cm² forming a mesh or screen with openings therein.

The wet cathode slurry mixture having the composition shown above in Table 1 comprising iron disulfide (FeS₂), binder, conductive carbon and solvents is prepared by mixing the components shown in Table 1 until a homogeneous mixture is obtained.

The above quantities (Table 1) of components of course can be scaled proportionally so that small or large batches of cathode slurry can be prepared. The wet cathode slurry thus preferably has the following composition: FeS₂ powder (58.9 wt. %); Binder, Kraton G1651 (2 wt. %); Graphite, Timrex KS6 (4.8 wt %), Actylene Black, Super P (0.7 wt %), Hydrocarbon Solvents, ShellSol A100 (13.4 wt %) and ShelSol OMS (20.2 wt %) The cathode slurry is coated onto one side (optionally both sides) of a conductive substrate or grid 65, preferably a sheet of aluminum, or stainless steel expanded metal foil. The cathode slurry coated on the metal substrate 65 is dried in an oven preferably gradually adjusting or ramping up the temperature from an initial temperature of 40° C. to a final temperature not to exceed 130° C. for about ½ hour or until the solvent has all evaporated. This forms a dry cathode coating 60 comprising FeS₂, carbon particles, and binder on the metal substrate 65 and thus forms the finished cathode composite sheet 62 shown best in FIG. 4. A calendering roller is then applied to the coating to obtain the desired cathode thicknesses. For an AA size cell, the desired thickness of dry/ cathode coating 60 is between about 0.172 and 0.188 mm, preferably about 0.176 mm. The dry cathode coating thus has the following desirable formulation: FeS₂ powder (89.0 wt. %); binder, Kraton G1651 elastomer (3.0 wt. %); conductive carbon particles, preferably graphite (7 wt. %) available as Timrex KS6 graphite from Timcal Ltd and conductive carbon black (1 wt %) available as Super P conductive carbon black from Timcal. The carbon black develops a carbon network which improves conductivity. Optionally between about 0 and 90 percent by weight of the total carbon particles may be graphite. The graphite if added may be natural, synthetic or expanded graphite and mixtures thereof. The dry cathode coating may typically comprise between about 85 and 95 wt. % iron disulfide (FeS₂); between about 4 and 8 wt. % conductive carbon; and the remainder of said dry coating comprising binder material.

The cathode conductive substrate 65 secures the cathode coating 60 and functions as a cathode current collector during cell discharge. Alternatively, the cathode composite 62 can be formed by coating one side of the conductive substrate 65 with a wet cathode slurry as above described, then drying the coating, and next applying a wet cathode slurry of same or similar composition to the opposite side of the cathode substrate 65. This can be followed by calendering the dried cathode coatings on substrate 64, thereby forming the completed cathode 62.

The anode 40 can be prepared from a solid sheet of lithium metal. The anode 40 is desirably formed of a continuous sheet of lithium metal (99.8% pure). Alternatively, the anode 40 can be an alloy of lithium and an alloy metal, for example, an alloy of lithium and aluminum. In such case the alloy metal, is present in very small quantity, preferably less than 1 percent by weight of the lithium alloy. Upon cell discharge the lithium in the alloy thus functions electrochemically as pure lithium. Thus, the term “lithium or lithium metal” as used herein and in the claims is intended to include in its meaning such lithium alloy. The lithium sheet forming anode 40 does not require a substrate. The lithium anode 40 can be advantageously formed from an extruded sheet of lithium metal having a thickness of desirably between about 0.10 and 0.20 mm desirably between about 0.12 and 0.19 mm, preferably about 0.15 mm for the spirally wound cell.

Individual sheets of electrolyte permeable separator material 50, preferably of microporous polypropylene having a thickness of about 0.025 mm is inserted on each side of the lithium anode sheet 40 (FIGS. 4 and 5). The microporous polypropylene desirably has a pore size between about 0.001 and 5 micron. The first (top) separator sheet 50 (FIG. 4) can be designated the outer separator sheet and the second sheet 50 (FIG. 4) can be designated the inner separator sheet. The cathode composite sheet 62 comprising cathode coating 60 on conductive substrate 65 is then placed against the inner separator sheet 50 to form the flat electrode composite 13 shown in FIG. 4. The flat composite 13 (FIG. 4) is spirally wound to form electrode spiral assembly 70 (FIG. 3). The winding can be accomplished using a mandrel to grip an extended separator edge 50b (FIG. 4) of electrode composite 13 and then spirally winding composite 13 clockwise to form wound electrode assembly 70 (FIG. 3).

When the winding is completed separator portion 50b appears within the core 98 of the wound electrode assembly 70 as shown in FIGS. 2 and 3. By way of non limiting example, the bottom edges 50a of each revolution of the separator may be heat formed into a continuous membrane 55 as shown in FIG. 3 and taught in U.S. Pat. No. 6,443,999. As may be seen from FIG. 3 the electrode spiral 70 has separator material 50 between anode sheet 40 and cathode composite 62. The spirally wound electrode assembly 70 has a configuration (FIG. 3) conforming to the shape of the casing body. The spirally wound electrode assembly 70 is inserted into the open end 30 of casing 20. As wound, the outer layer of the electrode spiral 70 comprises separator material 50 shown in FIGS. 2 and 3. An additional insulating layer 72, for example, a plastic film such as polyester tape, can desirably be placed over a of the outer separator layer 50, before the electrode composite 13 is wound. In such case the spirally wound electrode 70 will have insulating layer 72 in contact with the inside surface of casing 20 (FIGS. 2 and 3) when the wound electrode composite is inserted into the casing. Alternatively, the inside surface of the casing 20 can be coated with electrically insulating material 72 before the wound electrode spiral 70 is inserted into the casing.

A nonaqueous electrolyte mixture of the invention can then be added to the wound electrode spiral 70 after it is inserted into the cell casing 20. A desirable electrolyte of the invention comprising about 0.8 molar (0.8 mol/liter) concentration of the lithium salt Li (CF₃SO₂) ₂N (LiTFSI) dissolved in an organic solvent mixture comprising between about 50 and 95 vol. % 1,2-dimethoxyethane (DME) and between about 5 and 50 vol. % sulfolane (SL) may be added to the wound electrode spiral 70 within casing 20. A preferred electrolyte which may be added to wound electrode spiral 70 comprises Li(CF₃SO₂)₂N (LITFSI) salt (0.8 mols per liter concentration) dissolved in the organic solvent mixture comprising about 80 vol. % 1,2-dimethoxyethane (DME) and 20 vol. % sulfolane (SL). About 3000 ppm SnI₂ (parts per million parts by weight) is desirably added to the electrolyte. The electrolyte is added to the cell in amount equal to about 0.4 gram electrolyte solution per gram FeS₂ in the cathode. Such electrolyte for the Li/Fe₂ cell has a low viscosity of between about 0.9 and 1.5 centipoise, typically between about 1.0 and 1.5 centipoise.

An end cap 18 forming the cell's positive terminal 17 may have a metal tab 25 (cathode tab) which can be welded on one of its sides to inside surface of end cap 18. Metal tab 25 is preferably of aluminum or aluminum alloy. A portion of the cathode substrate 65 may be flared along its top edge forming an extended portion 64 extending from the top of the wound spiral as shown in FIG. 2. The flared cathode substrate portion 64 can be welded to the exposed side of metal tab 25 before the casing peripheral edge 22 is crimped around the end cap 18 with peripheral edge 85 of insulating disk 80 therebetween to close the cell's open end 30. End cap 18 desirably has a vent 19 which can contain a rupturable membrane designed to rupture and allow gas to escape if the gas pressure within the cell exceeds a predetermined level. Positive terminal 17 is desirably an integral portion of end cap 18. Alternatively, terminal 17 can be formed as the top of an end cap assembly of the type described in U.S. Pat. No. 5,879,832, which assembly can be inserted into an opening in the surface of end cap 18 and then welded thereto.

A metal tab 44 (anode tab), preferably of nickel can be pressed into a portion of the lithium metal anode 40. Anode tab 44 can be pressed into the lithium metal at any point within the spiral, for example, it can be pressed into the lithium metal at the outermost layer of the spiral as shown in FIG. 5. Anode tab 44 can be embossed on one side forming a plurality of raised portions on the side of the tab to be pressed into the lithium. The opposite side of tab 44 can be welded to the inside surface of the casing either to the inside surface of the casing side wall 24 or more preferably to the inside surface of close end 35 of casing 20 as shown in FIG. 3. It is preferable to weld anode tab 44 to the inside surface of the casing closed end 35, since this is readily accomplished by inserting an electrical spot welding probe (an elongated resistance welding electrode) into the cell core 98. Care should be taken to avoid contacting the welding probe to the separator starter tab 50b which is present along a portion of the outer boundary of cell core 98.

The primary lithium cell 10 may optionally also be provided with a PTC (positive thermal coefficient) device 95 located under the end cap 18 and connected in series between the cathode 60 and end cap 18 (FIG. 2). Such device protects the cell from discharge at a current drain higher than a predetermined level. Thus, if the cell is drained at an abnormally high current, e.g., higher than about 6 to 8 Amp, for a prolonged period, the resistance of the PTC device increases dramatically, thus shutting down the abnormally high drain. It will be appreciated that devices other than vent 19 and PTC device 95 may be employed to protect the cell from abusive use or discharge.

### EXAMPLE

### Experimental Test Lithium Coin Cells with Cathode Comprising FeS₂

Experimental test Li/FeS₂ coin cells 100 (FIG. 1A) were prepared as follows:

### Experimental Test Coin Cell Assembly:

A coin shaped cathode housing 130 of aluminum plated steel and a coin shaped anode housing 120 of nickel plated steel is formed of a similar configuration shown in FIG. 1A. The finished cell 100 had an overall diameter of about 20 mm and a thickness of about 3 mm. (This is the size of a conventional ASTM size 2032 coin cell.) The weight of FeS₂ in the cathode housing 130 was 0.0464 g. The lithium in the anode housing 120 was in electrochemical excess.

In forming each cell 100 a plastic insulating of ring shape 140 was first fitted around the side wall 122 of anode housing 120 (FIG. 1A). A spring ring 200 of stainless steel was placed against the inside surface of the anode housing 120. Ring 200 is inserted into anode housing 120 without the need to weld the ring to the anode housing 120. Ring 200, shown best in FIG. 1C, has a circumferential edge 255 bounding central aperture 250. Circumferential edge surface 255 has convolutions 257 (FIG. 1D) integrally formed therein so that edge surface 255 does not lie entirely in the same plane. When spring ring 200 is inserted into anode housing 120 and pressure is applied to the edge surface 255, convolutions 257 therein give the ring resilience and a spring effect. A spacer disk 300 having a flat solid surface 310 is then next inserted into the anode housing 120 so that it lies against spring ring 200 (FIG. 1A). More than one spacer disk 300 may be inserted on top of each other in stacked arrangement in order to provide a tight fit of the cell contents within the cell. In the test coin cell 100 three stainless steel spacer disks 300 were applied in stacked arrangement against spring ring 200.

A lithium disk 150 formed of a sheet of lithium metal having a thickness of 0.006 inch (0.15 mm) was punched out in a dry room using a 0.56 inch hand punch. The lithium disk 150 (FIG. 1A) forming the cell's anode was then pressed onto the underside of the spacer disks 300 using a hand press.

A cathode slurry was then prepared and coated over one side of an aluminum sheet (not shown). The components of the cathode slurry comprising iron disulfide (FeS₂) were mixed together in the following proportion:

FeS₂ powder (58.9 wt. %); Binder, styrene-ethylene/butylene-styrene elastomer (Kraton G1651) (2 wt. %); Graphite (Timrex KS6) (4.8 wt %), Carbon Black (Super P carbon black) (0.7 wt %), Hydrocarbon Solvents, ShellSol A100 solvent (13.4 wt %) and ShelSol OMS solvent (20.2 wt %).

The wet cathode slurry on the aluminum sheet was then dried in an oven between 40° C. and 130° C. until the solvent in the cathode slurry all evaporated, thus forming a dry cathode coating comprising FeS₂, conductive carbon and elastomeric binder coated on a side of the aluminum sheet. The aluminum sheet (not shown) was an aluminum foil of 20 micron thickness. The same composition of wet cathode slurry was then coated onto the opposite side of the aluminum sheet and similarly dried. The dried cathode coatings on each side of the aluminum sheet was calendered to form a dry cathode 170 having a total final thickness of about 0.171 mm, which includes the 20 micron thick aluminum foil.

The anode housing 120 is inverted so that its open end faces up. Separator disk 160 is inserted into the anode housing 120 so that it contacts the lithium anode disk 150. Separator disk 160 was of microporous polypropylene (Celgard CG2500 separator from Celgard, Inc.) The separator disk was previously punched out from sheets into the required disk shape using a hand punch having a diameter of 0.69 inch (17.5 mm).

A preferred electrolyte of the invention designated electrolyte no. 1 was prepared. The preferred electrolyte contained 0.8 molar (0.8 mol/liter) concentration of Li(CF₃SO₂)₂N (LiTFSI) salt dissolved in an organic solvent mixture comprising about 80 vol. % 1,2-dimethoxyethane (DME) and 20 vol. % sulfolane (SL). Then about 3200 parts by weight SnI₂ per million parts by weight electrolyte (ppm) was added to form the final electrolyte solution. With the anode housing 120 inverted with the open end on top, 0.2 gram of the electrolyte solution was added over separator 160.

The dried cathode 170 was cut to size in disk shape with a hand punch having a diameter of 0.44 inch (11.1 mm) and inserted into the anode housing 120 so that it contacts the electrolyte soaked separator 160. The dried cathode coating on one side of the aluminum sheet faces separator 160 and forms the anode active area. The dried cathode coating on the opposite side of the aluminum sheet is used primarily to keep the cathode from cracking and does not discharge. Thus the amount of FeS₂ in the cell which is subject to electrochemical discharge is one half the total amount present, that is, about 0.0232 g. The dry cathode coating 170 had the following composition: FeS₂ powder (89.0 wt. %); Binder Kraton G1651 elastomer (3.0 wt. %); conductive carbon particles, graphite Timrex KS6 (7 wt. %) and carbon acetylene black, Super P (1 wt %).

The cathode housing 130 was then placed over the filled anode housing 120 so that the side wall 136 of the cathode housing 130 covered side wall 122 of anode housing 120 with insulator 140 therebetween. The closed end 138 of the cathode housing 130 was centered within a mechanical crimper. A mechanical crimper arm was then pulled down all of the way to crimp the peripheral edge 135 of the cathode housing 130 over the edge 142 of insulating disk 140. This process was repeated for each of three identical test cell with same electrolyte no. 1, thus forming the completed coin cell 100 shown in FIG. 1A. After each cell had been formed, the outside surfaces of the housings of the cells were wiped cleaned with methanol. A set of identical control cells of same size as the test cells were prepared with same electrolyte no. 1 as above described but without the SnI₂ additive. The control cells had anode and cathode compositions and cell contents otherwise identical to the test cells.

A second set of test cells and corresponding set control cells were prepared using the same size cell and internal components as above described but with a different electrolyte, namely, electrolyte no. 2. The electrolyte no. 2 contained 1.0 molar (1.0 mol/liter) concentration of lithium iodide (LiI) salt dissolved in an organic solvent mixture comprising about 80 vol. % 1,2-dimethoxyethane (DME) and 20 vol. % sulfolane (SL). Then about 3300 parts by weight SnI₂ per million parts by weight electrolyte (ppm) was added to form the final electrolyte solution. With the anode housing 120 inverted with the open end on top, 0.2 gram of the electrolyte solution was added over separator 160. A set of identical control cells of same size as the test cells were prepared with same electrolyte no. 2 as above indicated, but without the SnI₂ additive. The control cells had anode and cathode compositions and cell contents otherwise identical to the second set of test cells.

A third set of test cells and corresponding set control cells were prepared using the same size cell and internal components as above described but with a different electrolyte, namely, electrolyte no. 3. The electrolyte no. 3 contained 0.8 molar (0.8 mol/liter) concentration of LiPF₆ salt dissolved in an organic solvent mixture comprising about 80 vol. % 1,2-dimethoxyethane (DME) and 20 vol. % ethylene carbonate (EC). Then about 2000 parts by weight SnI₂ per million parts by weight electrolyte (ppm) was added to form the final electrolyte solution. With the anode housing 120 inverted with the open end on top, 0.2 gram of the electrolyte solution was added over separator 160. A set of identical control cells of same size as the test cells were prepared with same electrolyte no. 3 as above indicated, but without the SnI₂ additive. The control cells had anode and cathode compositions and cell contents otherwise identical to the third set of test cells.

### Electrochemical Performance of Experimental Test Cells:

After identical test cells had been formed as above described, the discharge capacity of each cell was tested using a digital camera test that was meant to mimic the use of the cell in a digital camera.

The digital camera test (Digicam test) consists of the following pulse test protocol wherein each test cell was drained by applying pulsed discharge cycles to the cell: Each cycle consists of both a 6.5 milliwatt pulse for 2 seconds followed immediately by a 2.82 milliwatt pulse for 28 seconds. (The first pulse mimics the power of the digital camera required to take a picture and the second pulse mimics the power to view the picture taken.) The cycles are continued until a cutoff voltage of 1.05V is reached and then the cycles continued until a final cutoff voltage of 0.9 volt is reached. The number of cycles required to reach these cutoff voltages were recorded.

Before the cells were subjected to the above described Digicam test they were stored at room temperature for 2 hours and then were predischarged at a constant current drain of 1 milliAmp for 40 minutes. This corresponded to a depth of discharge of about 3 percent of the cell's capacity. To measure the effect of shelf life on the SnI₂ electrolyte additive some of the predischarged cells were stored in a 60° C. oven for 20 days. The individual cells were then subjected to the above indicated Digicam test designed to mimic usage in a digital camera. The results are reported in Table II.

TABLE II
Discharge Performance of Li/FeS₂ Coin Cells With
An Electrolyte Formulation of the Invention Showing
Benefit of Adding SnI₂ to the Electrolyte

Digicam Test
Number of
Pulsed Cycles³
Stored Cells⁴

| Electrolyte^{1,2} | Cell No. | 1.05 V | 0.90 V |
|---|---|---|---|
| Control 1 | 1 | 661 | 709 |
| Control 1 | 2 | 790 | 742 |
| Control 1 | 3 | 692 | 741 |
| | Average | 681 | 731 |
| Test 1 | 4 | 791 | 841 |
| (with SnI₂) | | | |
| Test 1 | 5 | 790 | 848 |
| (with SnI₂) | | | |
| Test 1 | 6 | 764 | 814 |
| (with SnI₂) | | | |
| | Average | 782 | 834 |

Notes:
¹Control Electrolyte 1 contained 0.8 molar (0.8 mol/liter) of Li(CF₃SO₂)₂N (LiTFSI) salt dissolved in an organic solvent mixture comprising 80 vol. % 1,2-dimethoxyethane (DME) and 20 vol. % sulfolane (SL).
²The Test Electrolyte 1 contained 0.8 molar (0.8 mol/liter) of Li(CF₃SO₂)₂N (LiTFSI) salt dissolved in an organic solvent mixture comprising 80 vol. % 1,2-dimethoxyethane (DME) and 20 vol. % sulfolane (SL) and tin iodide (SnI₂) added in amount 3200 ppm (parts per million parts electrolyte by weight)
³The pulsed cycle (Digicam Test) consists of both a 6.5 milliWatt pulse for 2 seconds followed immediately by a 2.82 milliWatt pulse for 28 seconds to mimic use in a digital camera. Number of pulsed cycles reported until cutoff voltage of 1.05 V and 0.90 V were reached. (Before Digicam Test the cells were.)
⁴Cells were stored at 60° C. for 20 days. Before the storage the cells were subjected to a predischarge at 1 milliAmp for 40 min, corresponding to a depth of discharge of about 3 percent of the cell's capacity.

TABLE III
Discharge Performance of Li/FeS₂ Coin Cells With
Another Electrolyte Formulation of the Invention
Showing Benefit of Adding SnI₂ to the Electrolyte

Digicam Test
Number of
Pulsed Cycles³
Stored Cells⁴

| Electrolyte^{1,2} | Cell No. | 1.05 V | 0.90 V |
|---|---|---|---|
| Control⁵ 2 | 7 | — | — |
| Control⁵ 2 | 8 | — | — |
| Control⁵ 2 | 9 | — | — |
| | Average | — | — |
| Test 2 | 10 | 780 | 847 |
| (with SnI₂) | | | |
| Test 2 | 11 | 791 | 831 |
| (with SnI₂) | | | |
| Test 2 | 12 | 773 | 811 |
| (with SnI₂) | | | |
| | Average | 781 | 830 |

Notes:
¹Control Electrolyte 2 contained 0.8 molar (0.8 mol/liter) of LiI salt dissolved in an organic solvent mixture comprising 80 vol. % 1,2-dimethoxyethane (DME) and 20 vol. % sulfolane (SL).
²The Test Electrolyte 2 contained 0.8 molar (0.8 mol/liter) of LiI salt dissolved in an organic solvent mixture comprising 80 vol. % 1,2-dimethoxyethane (DME) and 20 vol. % sulfolane (SL) and tin iodide (SnI₂) added in amount 3300 ppm (parts per million parts electrolyte by weight).
³The pulsed cycle (Digicam Test) consists of both a 6.5 milliWatt pulse for 2 seconds followed immediately by a 2.82 milliWatt pulse for 28 seconds to mimic use in a digital camera. Number of pulsed cycles reported until cutoff voltage of 1.05 V and 0.90 V were reached.
⁴Cells were stored at 60° C. for 20 days. Before the storage the cells were subjected to a predischarge at 1 milliAmp for 40 min, corresponding to a depth of discharge of about 3 percent of the cell's capacity.
⁵There was no Digicam test data for the control cells using electrolyte 2 without SnI₂ additive because of electrolyte leakage in the cells, believed due to excessive gassing.

TABLE IV
Discharge Performance of Li/FeS₂ Coin Cells With
Another Electrolyte Formulation of the Invention
Showing Benefit of Adding SnI₂ to the Electrolyte

Digicam Test
Number of
Pulsed Cycles³
Fresh Cells⁴

| Electrolyte^{1,2} | Cell No. | 1.05 V | 0.90 V |
|---|---|---|---|
| Control 3 | 13 | 5 | 664 |
| Control 3 | 14 | 6 | 713 |
| Control 3 | 15 | 5 | 702 |
| | Average | 5 | 693 |
| Test 3 | 16 | 719 | 778 |
| (with SnI₂) | | | |
| Test 3 | 17 | 631 | 695 |
| (with SnI₂) | | | |
| Test 3 | 18 | 704 | 763 |
| (with SnI₂) | | | |
| | Average | 685 | 745 |

Notes:
¹Control Electrolyte 3 contained 0.8 molar (0.8 mol/liter) of LiPF₆ salt dissolved in an organic solvent mixture comprising 80 vol. % 1,2-dimethoxyethane (DME) and 20 vol. % sulfolane (SL).
²The Test Electrolyte 3 contained 0.8 molar (0.8 mol/liter) of LiPF₆ salt dissolved in an organic solvent mixture comprising 80 vol. % 1,2-dimethoxyethane (DME) and 20 vol. % ethylene carbonate (EC) and tin iodide (SnI₂) added in amount 2000 ppm (parts by weight per million parts electrolyte by weight).
³The pulsed cycle (Digicam Test) consists of both a 6.5 milliWatt pulse for 2 seconds followed immediately by a 2.82 milliWatt pulse for 28 seconds to mimic use in a digital camera. Number of pulsed cycles reported until cutoff voltage of 1.05 V and 0.90 V were reached.
⁴Cells were stored fresh at room temperature for 2 hours and then subjected to a predischarge at 1 milliAmp for 40 min, corresponding to a depth of discharge of about 3 percent of the cell's capacity, before the pulsed cycle Digicam test. (The low number of pulses for the control cells 13, 14, and 15 (electrolyte without the SnI₂ additive) discharged fresh to a cutoff voltage of 1.05 V were as a result of the quick drop in voltage of these cells down to the cut off 1.05 V believed due to the rapid buildup of a passivation layer on the lithium anode.)

The above reported test results show a distinct benefit in adding relatively small amount of SnI₂ (less than 1 wt. %) to the various electrolytes tested when compared to the performance of identical Li/FeS2 cells the same electrolyte but without the SnI₂ additive. The electrolytes tested, namely, electrolytes 1, 2, and 3 all contained 1,2-dimethyoxyethane (DME) solvent in admixture with other solvents, e.g sulfolane (electrolytes 1 and 2 or ethylene carbonate (electrolyte 3). In every case whether the Li/FeS₂ cell was discharged to a cut off of 1.05V or 0.9V the electrolyte containing the SnI₂ additive showed a distinct improvement in number of pulsed cycles obtained when the Li/FeS2 cell was subjected to the Digicam pulsed discharge test. For example, for stored Li/FeS₂ cells subjected to the Digicam test to a cutoff of 0.9V cells cells with electrolyte 1 with SnI2 (3200 ppm) additive achieved an average of 834 pulsed cycles (equivalent to about 834 pictures with a digital camera) compared to an average of 731 pulsed cycles (equivalent to about 731 pictures) when identical cells without the SnI₂ were discharged.

The improvement in the Li/FeS2 cell performance is believed due primarily in the effect of the SnI₂ additive on reducing the rate of buildup of the passivation layer on the surface of the lithium anode. The SnI2 is believed to induce a stabilized passivation layer on the lithium anode surface, that is, it is believed to retard the rate of continued high rate buildup of the passivation layer. Thus a continued, substantial buildup of the passivation layer is prevented by the addition of the SnI₂ additive to the electrolyte. This in turn is reflected in better performance and capacity for the Li/FeS₂ cells with SnI₂ added to the electrolyte.

Additional tests were made to examine the cell's internal impedance for the cells tested, that is, those with SnI₂ added to the electrolyte compared to identical cells without the SnI₂. For the Li/FeS₂ cells with electrolyte 1, the measured internal impedance after cell storage at 60° C. for 20 days discharge was on average about 50% less for cells containing electrolyte 1 with the SnI₂ additive compared to those containing electrolyte 1 without the SnI₂. This supports our view that the SnI₂ additive retards the rate of continued buildup of passivation layer on the lithium anode surface of the Li/FeS₂ cell, since the lithium passivation layer is a principal cause for an increase in the cell's internal resistance.

Although the invention has been described with reference to specific embodiments, it should be appreciated that other embodiments are possible without departing from the concept of the invention and are thus within the claims and equivalents thereof.

What is claimed is:

1. A primary electrochemical cell comprising a housing; a positive and a negative terminal; an anode comprising lithium; a cathode comprising iron disulfide (FeS₂) and conductive carbon, said cell further comprising a nonaqueous electrolyte comprising a lithium salt dissolved in a nonaqueous solvent, wherein said nonaqueous solvent further comprises tin iodide (SnI₂) additive.

2. The cell of claim 1 wherein the lithium salt is selected from the group consisting of LiCF₃SO₃ (LITFS) and Li(CF₃SO₂)₂N (LiTFSI), and mixtures thereof.

3. The cell of claim 1 wherein the lithium salt comprises Li(CF₃SO₂)₂N (LiTFSI).

4. The cell of claim 1 wherein said nonaqueous solvent comprises dimethoxyethane.

5. The cell of claim 1 wherein the electrolyte comprises a lithium salt comprising Li(CF₃SO₂)₂N (LiTFSI) dissolved in a nonaqueous solvent comprising dimethoxyethane and tin iodide (SnI₂).

6. The cell of claim 5 wherein the nonaqueous solvent further comprises sulfolane.

7. The cell of claim 6 wherein the electrolyte has a viscosity between about 0.9 and 1.5 centipoise.

8. The cell of claim 7 wherein the electrolyte comprises between about 1000 and 5000 parts by weight tin iodide (SnI₂) therein per million parts electrolyte by weight.

9. The cell of claim 5 wherein the nonaqueous solvent is essentially free of dioxolane.

10. The cell of claim 5 wherein said nonaqueous solvent comprises less than 200 parts by weight of dioxolane per million parts by weight solvent.

11. The cell of claim 1 wherein said cathode comprising iron disulfide (FeS₂) and conductive carbon is coated onto a substrate sheet comprising aluminum.

12. The cell of claim 1 wherein the anode comprises a sheet of lithium or lithium alloy.

13. The cell of claim 1 wherein said cathode comprising iron disulfide (FeS₂) is in the form of a coating bound to a metallic substrate and wherein said anode comprising lithium and said cathode are arranged in spirally wound form with a separator material therebetween.

14. A primary electrochemical cell comprising a housing; a positive and a negative terminal; an anode comprising lithium; a cathode comprising iron disulfide (FeS₂) and conductive carbon, said cell further comprising a nonaqueous electrolyte comprising a lithium salt comprising lithium iodide (LiI) dissolved in a nonaqueous solvent comprising dimethoxyethane and tin iodide (SnI₂) additive.

15. The cell of claim 14 wherein the nonaqueous solvent further comprises sulfolane.

16. The cell of claim 14 wherein the electrolyte has a viscosity between about 0.9 and 1.5 centipoise.

17. The cell of claim 14 wherein the electrolyte comprises between about 1000 and 5000 parts by weight tin iodide (SnI₂) therein per million parts electrolyte by weight.

18. The cell of claim 14 wherein the nonaqueous solvent is essentially free of dioxolane.

19. The cell of claim 14 wherein said nonaqueous solvent comprises less than 200 parts by weight of dioxolane per million parts by weight solvent.

20. The cell of claim 14 wherein said cathode comprising iron disulfide (FeS₂) and conductive carbon is coated onto a substrate sheet comprising aluminum.

21. The cell of claim 14 wherein the anode comprises a sheet of lithium or lithium alloy.

22. The cell of claim 14 wherein said cathode comprising iron disulfide (FeS₂) is in the form of a coating bound to a metallic substrate and wherein said anode comprising lithium and said cathode are arranged in spirally wound form with a separator material therebetween.

23. A primary electrochemical cell comprising a housing; a positive and a negative terminal; an anode comprising lithium; a cathode comprising iron disulfide (FeS₂) and conductive carbon, said cell further comprising a nonaqueous electrolyte comprising a lithium salt comprising LiPF₆ dissolved in a nonaqueous solvent comprising dimethoxyethane and tin iodide (SnI₂) additive.

24. The cell of claim 23 wherein the nonaqueous solvent further comprises ethylene carbonate.

25. The cell of claim 23 wherein the electrolyte has a viscosity between about 0.9 and 1.5 centipoise.

26. The cell of claim 23 wherein the electrolyte comprises between about 1000 and 5000 parts by weight tin iodide (SnI₂) therein per million parts electrolyte by weight.

27. The cell of claim 23 wherein the nonaqueous solvent is essentially free of dioxolane.

28. The cell of claim 23 wherein said nonaqueous solvent comprises less than 200 parts by weight of dioxolane per million parts by weight solvent.

29. The cell of claim 23 wherein said cathode comprising iron disulfide (FeS₂) and conductive carbon is coated onto a substrate sheet comprising aluminum.

30. The cell of claim 23 wherein the anode comprises a sheet of lithium or lithium alloy.

31. The cell of claim 23 wherein said cathode comprising iron disulfide (FeS₂) is in the form of a coating bound to a metallic substrate and wherein said anode comprising lithium and said cathode are arranged in spirally wound form with a separator material therebetween.
